(19) United States
(12) Patent Application Publication
(10) Pub. No.: US 2011/0273809 A1
(43) Pub. Date: Nov. 10, 2011

(54) Method and Device for Protecting a Lithium Ion Battery in a Vehicle

(75) Inventors: Rainer Falsett, Babenhausen (DE); Rainer Mackel, Konigswinter (DE); Thomas Schulz, Unterensingen (DE)

(73) Assignee: INNOFONT GMBH & CO KG, Darmstadt (DE)

(21) Appl. No.: 13/141,860

(22) PCT Filed: Dec. 16, 2009
(86) PCT No.: PCT/EP09/67290

§ 371 Date: Jul. 18, 2011

(30) Foreign Application Priority Data
Dec. 24, 2008 (DE) 10 2008 063 136.1

(51) Int. Cl. H02H 5/04

(52) U.S. Cl. 361/104; 361/103

(57) ABSTRACT

The invention relates to a method for protecting a lithium ion battery (1) in a vehicle. According to the invention, in the case of thermal and/or electrical overload the lithium ion battery (1) is disconnected from an electrical system (4) of a vehicle.

The invention also relates to a device for protecting a lithium ion battery (1) in a vehicle.

The invention relates to a method for protecting a lithium ion battery in a vehicle according to the pre-characterising clause of claim 1. The invention also relates to a device for carrying out the method according to the pre-characterising clause of claim 4.

Conventional batteries can fall into a thermally uncontrollable state under severe load or in the case of overload (for example in the case of overcharging or excessive discharge current, by way of example in the case of a short circuit), in the event of damage (for example an accident, electrolyte disintegration) or even during normal operation in the case of severe external heating. In this respect they can overheat, build up a dangerous internal pressure (also called cell internal pressure) through to bursting or explosion of the cell and the casing, whereby dangerous substances are released. There is a particular risk specifically in the field of modern lithium or lithium ion batteries since these batteries contain liquid, flammable, organic electrolytes. Under adverse conditions these batteries can catch fire and constitute a problem in terms of safety. Safety valves are therefore integrated in conventional batteries which release overpressure in the battery in a controlled manner and which are intended to prevent an outbreak of fire or thermal destruction of the battery. A conventional battery is irreversibly damaged as a result and has to be replaced.

A conventional electronic battery device is used to determine certain parameters and/or operating states of an electrochemical energy store, in particular a battery of a motor vehicle. These operating states are, for example, what is referred to as the charging state, also known as the state of charge (SOC), the battery aging, also known as the state of health (SOH) and the ability to perform certain vehicle functions, also known as the state of function (SOF). Said values cannot be directly measured in a vehicle battery during operation but are calculated from the physically accessible parameters voltage, current and temperature of the battery.

In conventional vehicles a disconnector is present, formed for example as a pyrotechnic switch, relay and/or reversible fuse. This disconnector is used as a crash switch-off circuit and disconnects a vehicle electrical system from a battery in the case of an accident. The vehicle electrical system is consequently protected against short circuits and fires or the like resulting therefrom.

The invention is based on the object of disclosing an improved method for protecting a lithium ion battery and an improved device for carrying out the method.

With respect to the method, the object is achieved by the features disclosed in claim 1 and with respect to the device for carrying out the method, is achieved by the features disclosed in claim 4.

Advantageous developments of the invention are the subject matter of the subclaims.

With the method according to the invention for protecting a lithium ion battery in a vehicle the lithium ion battery is disconnected from an electrical system of a vehicle in the case of thermal and/or electrical overload.

Parameters of the lithium ion battery are expediently automatically monitored by means of an battery electronics circuit.

A current value, a voltage value, a temperature value and/or a cell internal pressure is/are determined as at least one parameter of the lithium ion battery.

In a lithium ion battery a temperature and an internal pressure increase significantly in the case of a malfunction, by way of example in the case of a short circuit or an overcharge, since an electrochemically active compound contained in the lithium ion battery, for example a metal oxide or metal phosphate, is thermally unstable and irreversibly disintegrates in an exothermic reaction above a certain temperature. The lithium ion battery becomes even hotter due to this disintegration process and the internal pressure continues to increase. This can lead to such lithium ion batteries exploding and/or releasing harmful substances.

To prevent this, a connection between the lithium ion battery and an electrical system in the vehicle can be permanently interrupted by means of the solution according to the invention even before an explosion and/or release of harmful substances.

In one possible embodiment a disconnector is arranged in the vehicle between the lithium ion battery and the vehicle electrical system. The lithium ion battery can consequently be disconnected from the vehicle electrical system in the case of thermal and/or electrical overload.

The disconnector is expediently a relay, a reversible fuse or a pyrotechnic switch, by way of example.

The parameters of the lithium ion battery can be automatically monitored by means of an battery electronics circuit.

A current value, a voltage value, a temperature value and/or a cell internal pressure can be determined as parameters by means of a detection unit. A critical state of the lithium ion battery can therefore be recognised early and the lithium ion battery can be disconnected from the vehicle electrical system by means of the disconnector in a manner controlled by the battery electronics circuit when limit values stored in the electronic battery device are exceeded.

A lithium ion battery of this kind can preferably be used in a vehicle with hybrid drive or in a fuel cell vehicle. These vehicles require very powerful lithium ion batteries which are to be accommodated in a very limited installation space. A very high level of protection is to be ensured with lithium ion batteries used in vehicles of this kind since damage to one or more lithium ion battery/batteries, by way of example an explosion and/or the egress of harmful substances from the lithium ion batteries, could have serious consequences for the vehicle and its occupants, for example damage to the vehicle, poisoning of and/or burns to the occupants, vehicle fire in the case of overheating of the lithium ion battery or a vehicle accident caused by an explosion of the lithium ion battery or the effects thereof. The solution according to the invention ensures that such vehicles can be efficiently and safely operated.

An embodiment of the invention will be described in more detail below with reference to the drawing, in which:

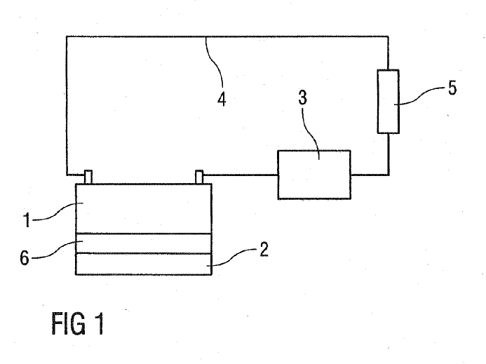

FIG. 1 shows a schematic view of a device according to the invention in a vehicle electrical system.

In the method according to the invention a lithium ion battery 1 in an electrical system 4 of a vehicle not shown in more detail is automatically monitored by means of an battery electronics circuit 2.

The battery electronics circuit 2 automatically monitors parameters and/or operating states of the lithium ion battery 1 by means of a detection unit 6. A current value, a voltage value, a temperature value and/or a cell internal pressure is/are determined as at least one such parameter of the lithium ion battery 1.

The current value of the lithium ion battery 1 is, by way of example, measured using what is known as a shunt resistor. This means the current flowing via the vehicle electrical system 4, in particular an earth cable of the vehicle, into the lithium ion battery 1 is led across a shunt resistor, wherein a voltage drop occurs at the shunt resistor which is proportional to the flowing current. The voltage dropping at the shunt resistor is tapped and supplied to an electrical measuring circuit for evaluation of the signal, hereinafter called the battery electronics circuit 2. The detection unit 6 also includes a device for measuring the voltage value of the lithium ion battery 1 and/or a device for measuring the temperature value and a device for measuring the cell internal pressure of the lithium ion battery 1.

The device for measuring the temperature value is preferably formed by a temperature sensor, for example a platinum temperature sensor, what is known as an NTC temperature sensor (negative temperature coefficient thermistor) or PTC temperature sensor (positive temperature coefficient thermistor).

The device for measuring the cell internal pressure is preferably formed by a pressure sensor, for example a piezoresistive, piezoelectrical or a capacitive pressure sensor.

Threshold values for the individual parameters are stored in the battery electronics circuit 2 and when these threshold values are exceeded a disconnector 3 is opened by the battery electronics circuit 2 in a controlled manner. Exceeding of these limit values primarily takes place in the case of overcharge or a short circuit.

The battery electronics circuit 2 and the detection unit 6 are preferably arranged so as to be spatially integrated in or on a housing of the lithium ion battery 1.

The disconnector 3 is arranged between the vehicle electrical system 4 and the lithium ion battery 1. When the disconnector 3 is opened the lithium ion battery 1 is electrically disconnected from the vehicle electrical system 4 and at least one load 5 arranged therein. A disconnector of this kind is constructed, for example, as a relay, a reversible fuse or a pyrotechnic switch. This disconnector may also be spatially arranged in the housing of the battery.

The pyrotechnic switch is constructed in such a way that a pyrotechnic charge is integrated in a current path and the current path can be broken by igniting the pyrotechnic charge such that a flow of current is interrupted. This igniting of the pyrotechnic charge can be controlled by the battery electronics circuit 2.

A critical state of the lithium ion battery 1 can be recognised early by means of the battery electronics circuit 2 and the detection unit 6 and the lithium ion battery 1 can be disconnected from the vehicle electrical system 4 and at least one load 5 arranged therein by means of the disconnector 3 in a manner controlled by the battery electronics circuit 2 when limit values stored in the battery electronics circuit 2 are exceeded.

In a lithium ion battery 1 a temperature and an internal pressure increase significantly in the case of a malfunction, by way of example in the case of a short circuit or an overcharge, since an electrochemically active compound contained in the lithium ion battery 1, for example a metal oxide or metal phosphate, is thermally unstable and irreversibly disintegrates in an exothermic reaction above a certain temperature. The lithium ion battery 1 becomes even hotter due to this disintegration process and the internal pressure continues to increase. This can lead to a lithium ion battery 1 of this kind exploding and/or releasing harmful substances.

To prevent this, a connection between the lithium ion battery 1 and an electrical system 4 in the vehicle can be permanently interrupted by means of the solution according to the invention even before an explosion and/or release of harmful substances.

A lithium ion battery 1 of this kind can preferably be used in a vehicle with hybrid drive, in a fuel cell vehicle or a battery-powered electric vehicle. A lithium ion battery 1 of this kind can also be used as a starter battery or vehicle electrical system battery in a conventional vehicle. These vehicles require very powerful lithium ion batteries 1 which are to be accommodated in a very limited installation space. A very high level of protection is to be ensured with lithium ion batteries 1 used in vehicles of this kind since damage to one or more lithium ion battery/batteries 1, for example an explosion and/or the egress of harmful substances from the lithium ion batteries 1, could have serious consequences for the vehicle and its occupants, for example damage to the vehicle, poisoning of and/or burns to the occupants, vehicle fire in the case of overheating of the lithium ion battery 1 or a vehicle accident caused by an explosion of the lithium ion battery 1 or the effects thereof. The solution according to the invention ensures that such vehicles can be efficiently and safely operated.

### LIST OF REFERENCE NUMERALS

1 lithium ion battery
2 electronic battery device
3 disconnector
4 vehicle electrical system
5 load
6 detection unit

1-11. (canceled)

12. Method for protecting a lithium ion battery in a vehicle comprising:
determining a cell internal pressure of the lithium ion battery as one parameter of at least one parameters of the lithium ion battery; and
disconnecting the lithium ion battery from an electrical system of the vehicle in the case of at least one of a thermal overload or an electrical overload of the battery.

13. Method of claim 12, wherein the at least one parameters of the lithium ion battery are automatically monitored by means of an electronic battery device.

14. Method of claim 12, further comprising determining at least one of a current value, a voltage value or a temperature value of the lithium ion battery.

15. Method of claim 12, wherein the thermal overload or the electrical overload for causing disconnecting is indicated by a determination that a predefined threshold of at least one of the parameters is exceeded and/or fallen below.

16. Device for protecting a lithium ion battery in a vehicle, wherein in the case of at least one of an overload thermal or an electrical overload the lithium ion battery can be disconnected from an electrical system of a vehicle by means of a disconnector, comprising:
a pressure sensor that detects at least one parameter of the lithium ion battery.

17. Device of claim 16, wherein the disconnector is a relay.

18. Device of claim 16, wherein the disconnector is a reversible fuse.

19. Device of claim 16, wherein the disconnector is a pyrotechnic switch.

20. Device of claim 19, wherein the pyrotechnic switch is configured in such a way that a pyrotechnic charge is integrated in a current path and by igniting the pyrotechnic charge the current path can be broken in such a way that a flow of current is interrupted.

21. Device of claim 16, wherein parameters of the lithium ion battery can be automatically monitored by means of a battery electronics device.

22. Device of claim 16, further comprising at least one of a current sensor, a voltage sensor, or a temperature sensor for detecting at least one lithium ion battery parameter.
